(19) United States
(12) Patent Application Publication
(10) Pub. No.: US 2006/0154160 A1
(43) Pub. Date: Jul. 13, 2006

(54) Photoconductors

(75) Inventors: Chien-Chung Bi, Hsinchu County (TW); Chen-Jen Yang, Hsinchu City (TW)

Correspondence Address: BIRCH STEWART KOLASCH & BIRCH, PO BOX 747, FALLS CHURCH, VA, 22040-0747, US

(73) Assignee: SINONAR Corp.

(21) Appl. No.: 11/211,583

(22) Filed: Aug. 26, 2005

(30) Foreign Application Priority Data
Jan. 7, 2005 (TW) 94100465

(51) Int. Cl. G03G 5/047

(52) U.S. Cl. 430/59.6; 430/58.2

(57) ABSTRACT

A photoconductor. The photoconductor includes a substrate, a charge generation layer thereon, and a charge transfer layer on the charge generation layer comprising a resin modified by a reactive silane.

### BACKGROUND

The present invention relates to a photoconductor, and more specifically to a photoconductor comprising a novel charge transfer layer.

Generally, photoconductors are used in laser printers and copiers to capture, transfer, and generate patterns. Printing processes of a laser printer are illustrated as follows.

Laser printing processes comprising charging, exposure, development, transfer, fusing, cleaning, and erasure are performed continuously and repeatedly until printing is completed.

When a command is issued via an application to a laser printer, negative or positive charges are immediately distributed over a photoconductor thereof such as organic photoconductor (OPC) or OPC drum. Image patterns are then projected to the photoconductor through laser and exposed. When the fast rolling photoconductor passes through a toner cartridge, the exposed region absorbs counter-charge toners to develop the image. Next, media is fed into the printer and charged counter to the toners. The toner image on the photoconductor is then transferred to and fused on the media through high temperature and pressure process. Remaining toner on the photoconductor is removed by a scraper, after which the potential of the photoconductor surface returns to the initial state, in preparation for the next cycle.

During printing, all operations are based on the photoconductor, significantly affecting printer quality.

A photoconductor base structure is illustrated in FIG. 1. The photoconductor comprises an aluminum substrate 10, a charge generation layer (CGL) 20, a charge transfer layer (CTL) 30, and a protective layer (PL) 40. After the top of the multi-layer photoconductor is irradiated by laser, electron/hole pairs are formed in the charge generation layer 20. Electron/hole pairs, however, have different flow directions. Electrons flow toward the aluminum substrate 10 and holes flow toward the top of the multi-layer photoconductor through the charge transfer layer 30 to form a latent image. The latent image then absorbs toner and is transferred to the media to generate a visible image. The surface of the photoconductor may be abraded during operation due to contact with scraper, roller, toners, or media, or be weathered by environmental effects such as humidity. A photoconductor can be protected by coating a protective layer on a charge transfer layer or adding abrasion-resistant or lubricant materials to a charge transfer layer, as shown in FIG. 2.

U.S. Pat. Nos. 5,485,250, 5,610,690, 5,905,008, 6,203,954, 6,326,111, 6,337,166, and 6,395,441 disclose addition of a fluorine resin, such as Teflon (polytetrafluoroethylene, PTFE), and various dispersants to a change transfer layer to reduce surface energy. The fluorine resin, however, is dispersed non-uniformly in the dispersants, deteriorating electrical performance.

U.S. Pat. Nos. 5,208,128 and 5,994,014 disclose addition of a polysiloxane resin with various powder or microsphere types or modified functional groups to a charge transfer layer. The polysiloxane resin, however, provides low long-term dispersion stability therein, causing powder subsidence in the coating solution during production even though siloxane powders modified by hydrophobic groups are used.

U.S. Pat. No. 6,071,660 discloses addition of polyolefin powders to a charge transfer layer. Such powder, however, also provides low dispersion stability therein.

U.S. Pat. Nos. 4,260,671 and 6,194,111 disclose addition of cross-linking polymers to a charge transfer layer to increase hardness thereof, resisting abrasion. The cross-linking reaction, however, may deteriorate electrical performance.

Thus, there exists a strong need in the art for a charge transfer layer with high abrasion and scrape resistance, lubricity, and low surface energy to prevent toner filming, and maintain adhesion of resin and electrical performance simultaneously.

### SUMMARY

The invention provides a photoconductor comprising a substrate, a charge generation layer thereon, and a charge transfer layer on the charge generation layer comprising a resin modified by a reactive silane.

The invention provides another photoconductor comprising a substrate, a charge generation layer thereon, and a charge transfer layer on the charge generation layer comprising a resin modified by a reactive silane and a hybrid powder comprising silicon dioxide and siloxane.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1 and 2 are cross sections of conventional photoconductors.

FIG. 3 is a cross section of a photoconductor of an embodiment of the invention.

FIG. 4 is a cross section of a photoconductor of another embodiment of the invention.

FIG. 5 illustrates a dispersion stability test of the invention.

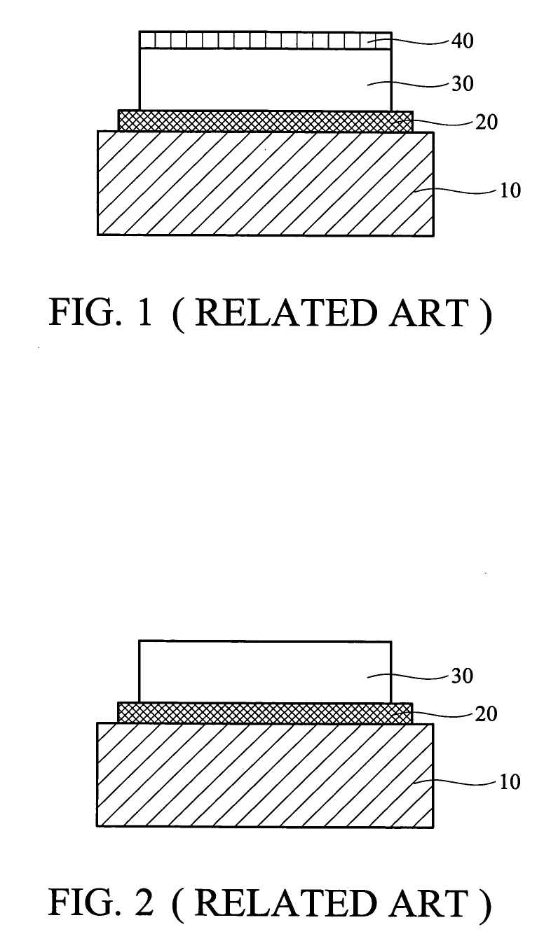

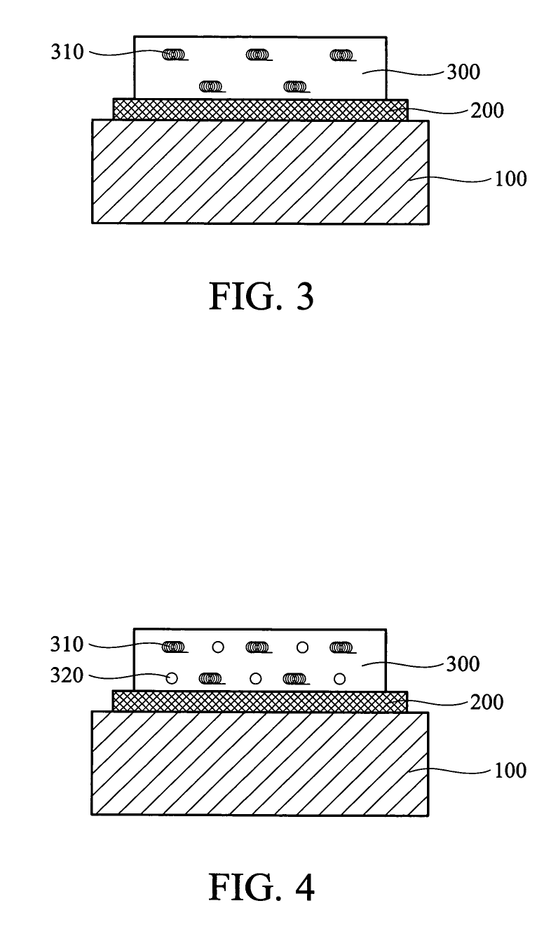

### DETAILED DESCRIPTION

The invention provides a chemically modified resin to increase hardness of charge transfer layer. The modified charge transfer layer improves abrasion and scrape resistance, lubricity, and reduces surface energy thereof to prevent toner filming and maintain adhesion of resin and electrical performance simultaneously, prolonging device lifetime.

The modified resin is formed by heating with silane. The resin may be polycarbonate (PC) such as Z-type polycarbonate having the formula. 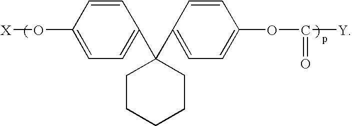
In the formula, X is hydrogen, Y is chlorine atom or hydroxyl group, and p is 50˜250.

The silane may comprise

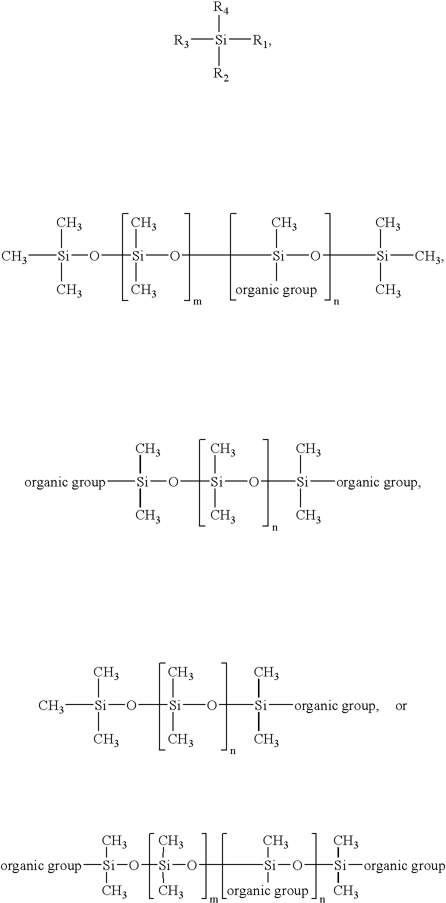

In the above formulae, R₁ may comprise halogen atom, alkyl, alkenyl, cycloalkyl, aryl, alkoxy, alkenyloxy, cycloalkoxy, acyl, or acyloxy. R₂, R₃, and R₄ may comprise halogen atom, alkyl halide, alkyl, or alkoxy. m and n are 0˜1000. The organic group may comprise halogen atom, amino, epoxy, carboxyl, carbinol, methacryl, mercapto, phenol, alkyl, alkenyl, cycloalkyl, aryl, alkoxy, alkenyloxy, cycloalkoxy, acyl, acyloxy, epoxy ether, or amino ether.

The silane compounds provided by the invention comprise:

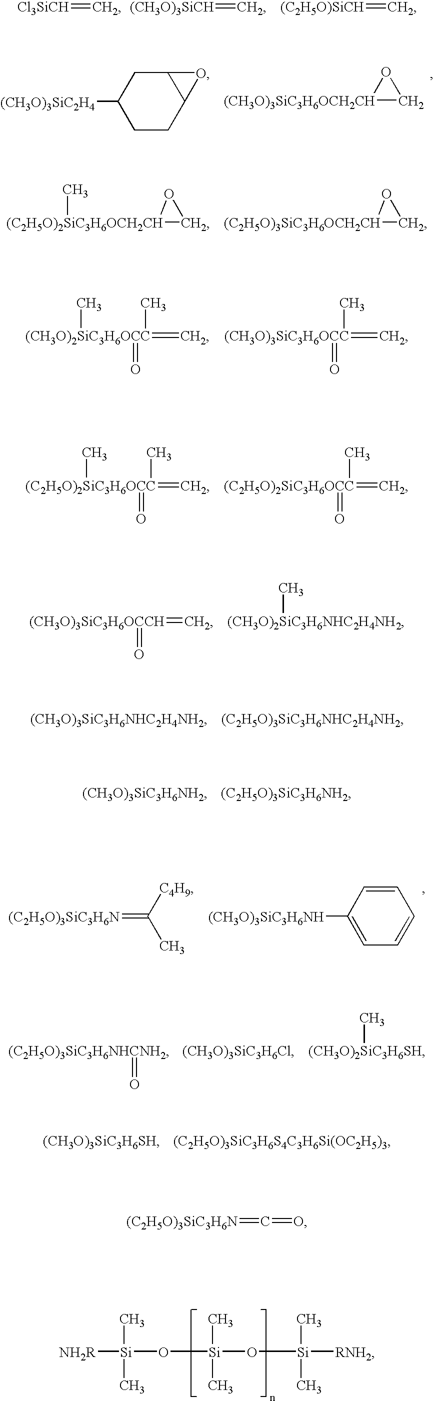

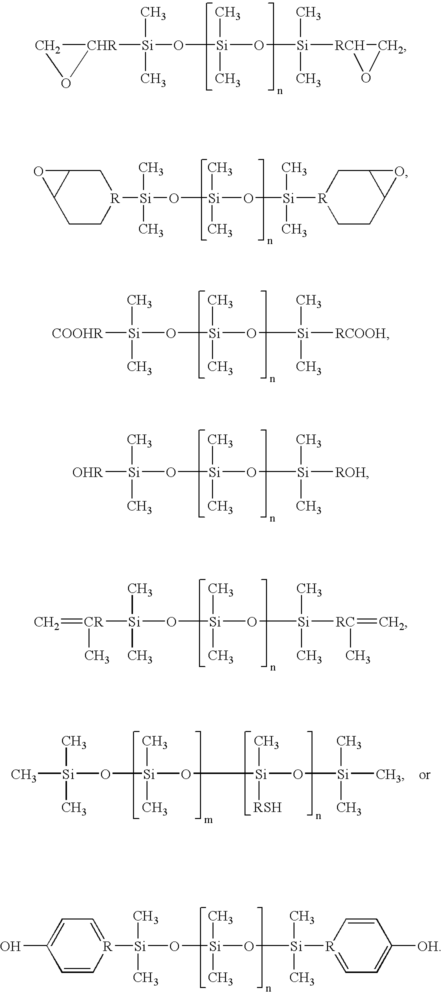

After the reactive silane and polycarbonate resin are mixed and heated at a proper temperature for a period of time, the organic functional groups of the reactive silane are chemically grafted onto the terminal groups of the polycarbonate, rather than physically blended, thereby altering the nature of the polycarbonate resin. The silane and the polycarbonate resin have a weight ratio of about 1:10000˜1:1, preferably 1:1000˜1:5. If the modified resin is utilized in a multi-layer photoconductor, tolerance to temperature or humidity alteration is enhanced. Abrasion resistance of the photoconductor surface can also be increased thereby, prolonging device lifetime.

Additionally, the modified charge transfer layer further comprises a hybrid powder consisting of a siloxane rubber microsphere covered by siloxane resin. The hybrid powder dispersion in a charge transfer layer solution is optimal due to chemical structure similar to the modified resin, no powder subsidence even though settling time increases. The hybrid powder and the modified resin have a weight ratio of about 0.01˜100%, preferably 1˜20%. The powder has a diameter of about 0.05˜50 μm.

Referring to FIGS. 3 and 4, the photoconductor provided by the invention comprises a substrate 100, a charge generation layer 200, and a charge transfer layer 300. The substrate 100 is an aluminum substrate. The charge generation layer 200 may comprise oxytitanium phthalocyanine (TiOPc) and poly vinyl butyral (PVB) resin. The charge transfer layer 300 may comprise hydrazone, the modified resin 310, or the hybrid powder 320.

### EXAMPLES

### Example 1

Preparation of charge Transfer Layer Solution

20 units of tetrahydrofuran (THF), 20 units of toluene, 5 units of polycarbonate, and 4 units of hydrazone were mixed and heated to 30° C. until completely dissolved. 0.5 unit of reactive silane containing amino groups 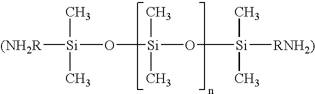
was then added and heated at 60° C. for 12 hours to form a charge transfer layer solution. In the above formula, the functional group equivalent is 1500 and n is 100˜200.
Fabrication of Photoconductor

A charge generation layer at a thickness of 0.5 μm (comprising oxytitanium phthalocyanine (TiOPc) and poly vinyl butyral (PVB) resin with a weight ratio of 1:1) and a charge transfer layer at a thickness of 20 μm were formed in order on a columnar aluminum substrate by dipping. The charge generation layer was baked at 50° C. for 30 min. The charge transfer layer was baked at 120° C. for 1 hour. The aluminum substrate had a diameter of 24 mm and a length of 246 mm.

Electrical, Print, and Mechanical Properties, and Adhesion Testing of Photoconductor

Electrical properties of photoconductor were measured by a photo-induced discharge curve (PIDC) method. A negative voltage of −690 (V₀) was applied to the photoconductor surface by electrical corona for 2 sec under light shade to achieve a dark development potential (V_{ddp}) thereof. The photoconductor surface was then exposed by a halogen light source at 780 nm and 2 μJ/cm² energy density for 2 sec to form a residual potential (Vr) thereof. Another parameter, half-exposure energy (E_{1/2}), is defined as a required light energy which reduces V_{ddp} to half. Lower E_{1/2} exhibits higher light sensitivity. Test results are shown in Table 1.

A HP-4300 commercial laser printer (45 pages/min) printed at 25° C. and 55% relative humidity, with common drawbacks such as positive/negative ghosting, density, interference fringe, and resolution, were compared in various environmental conditions, such as 25° C. and 55% relative humidity, 35° C. and 85% relative humidity, and 10° C. and 25% relative humidity, as shown in Tables 2, 3, and 4.

Mechanical properties were tested by a 6BTG torque gauge (Tohnichi Co., Ltd) and compared with a relative frictional coefficient defined as a ratio of a torque value of photoconductor in various conditions to a torque value of a new photoconductor. Test results are shown in Table 5.

Adhesion between layers was tested by binding scotch tape to the photoconductor surface and ripping. Test results are shown in Table 6.

Examples 2˜9 are similar to Example 1 in charge transfer layer solution preparation, photoconductor fabrication, and testing methods. The distinction therebetween is use of various reactive silanes.

### Example 2

The reactive silane was 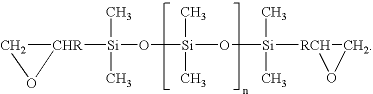
The functional group equivalent thereof is 1760 and n is 120˜200.

### Example 3

The reactive silane was 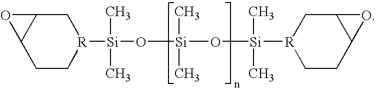
The functional group equivalent thereof is 3600 and n is 180˜260.

### Example 4

The reactive silane was 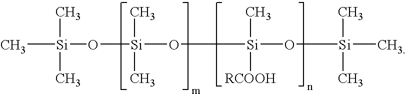
The functional group equivalent thereof is 3800 and m and n are 150˜250.

### Example 5

The reactive silane was 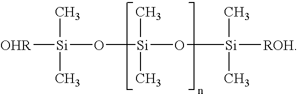
The functional group equivalent thereof is 120 and n is 25˜80.

### Example 6

The reactive silane was 3-aminopropyl tris(trimethylsiloxy) silane (C₁₂H₃₅NO₃Si₄) having a molecular weight of 353.76.

### Example 7

The reactive silane was decamethyl tetrasiloxane (C₁₀H₃₀O₃Si₄) having a molecular weight of 310.69.

### Example 8

The reactive silane was 1,3-divinyl tetramethyl disiloxane (C₈H₁₈OSi₂) having a molecular weight of 186.4.

### Example 9

The reactive silane was dodecamethyl pentasiloxane (C₁₂H₃₆O₄Si₅) having a molecular weight of 384.84.

### Examples 10˜12

These examples are similar to Example 1 in charge transfer layer solution preparation, photoconductor fabrication, and testing methods. The distinction therebetween is weight ratio of the reactive silane being altered to 0.05, 1.5, and 5 units.

### Example 13

20 units of tetrahydrofuran (THF), 20 units of toluene, 5 units of polycarbonate, and 4 units of hydrazone were mixed and heated to 30° C. until completely dissolved. 1 unit of reactive silane containing amino groups 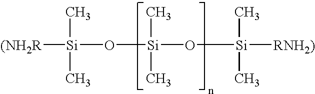
was then added and heated at 60° C. for 12 hours. In the above formula, the functional group equivalent is 1500 and n is 100˜200. After reaction, hybrid powders were added with stirring at room temperature for 6 hours to form a charge transfer layer solution.
Electrical, Print, and Mechanical Properties, and Adhesion Testing of Photoconductor, and Hybrid Powder Dispersion Stability Test

The electrical, print, and mechanical properties, and adhesion testing of photoconductor are similar to Example 1. The hybrid powder dispersion stability test is illustrated as follows.

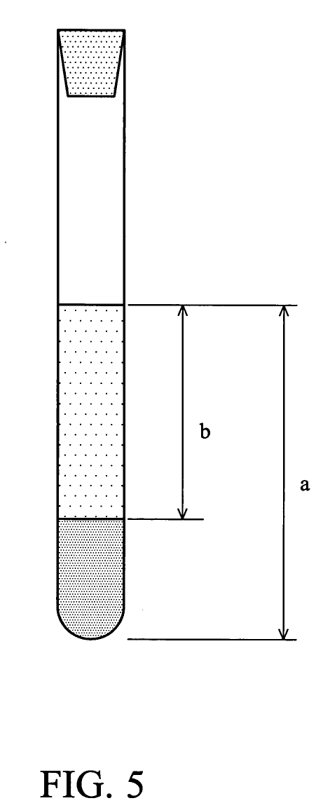

Referring to FIG. 5, a charge transfer layer solution containing hybrid powders was added to a tube. The tests were performed with a centrifuge and settling, respectively.

Centrifuge time was 1, 2, and 3 hours, respectively.

Settling time was one week, one month, two months, and half year, respectively.

In FIG. 5, a represents total solution length, b represents clear solution length. Various dispersion stabilities were compared with b/a*100%. As b/a*100% decreases, dispersion stability increases. Results are shown in Table 7.

### Examples 14˜15

These examples are similar to Example 13 in charge transfer layer solution preparation, photoconductor fabrication, and testing methods. The distinction therebetween is weight ratio of the hybrid powders being altered to 5 and 10 units.

Examples 16˜22 are similar to Example 13 in charge transfer layer solution preparation, photoconductor fabrication, and testing methods. The distinction therebetween is use of various reactive silanes.

### Example 16

The reactive silane was 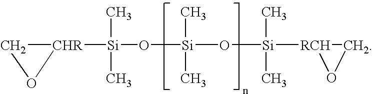
The functional group equivalent thereof is 1760 and n is 120˜200.

### Example 17

The reactive silane was 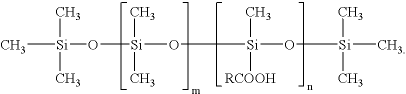
The functional group equivalent thereof is 3800 and m and n are 150˜250.

### Example 18

The reactive silane was 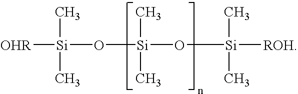
The functional group equivalent thereof is 120 and n is 25˜80.

### Example 19

The reactive silane was 3-aminopropyl tris(trimethylsiloxy)silane (C₁₂H₃₅NO₃Si₄) having a molecular weight of 353.76.

### Example 20

The reactive silane was decamethyl tetrasiloxane (C₁₀H₃₀O₃Si₄) having a molecular weight of 310.69.

### Example 21

The reactive silane was 1,3-divinyl tetramethyl disiloxane (C₈H₁₈OSi₂) having a molecular weight of 186.4.

### Example 22

The reactive silane was dodecamethyl pentasiloxane (C₁₂H₃₆O₄Si₅) having a molecular weight of 384.84.

### Comparative Example 1

Preparation of Charge Transfer Layer Solution

20 units of tetrahydrofuran (THF), 20 units of toluene, 5 units of polycarbonate, and 4 units of hydrazone were mixed and heated to 30° C. until completely dissolved.

Photoconductor fabrication and testing methods are similar to Example 1.

### Comparative Example 2

This example is similar to Example 13 in charge transfer layer solution preparation, photoconductor fabrication, and testing methods. The distinction therebetween is use of non-hybrid powders such as silicon resin (CWMP1590, Chemiwell Corp.).

### Comparative Example 3

This example is similar to Example 13 in charge transfer layer solution preparation, photoconductor fabrication, and testing methods. The distinction therebetween is use of polytetrafluoroethylene (PTFE) powders.

### Comparative Examples 4 and 5

These examples are similar to Examples 1 and 2, respectively, in charge transfer layer solution preparation, photoconductor fabrication, and testing methods. The distinction therebetween is stirring without heating after addition of reactive silane.

Comparative Examples 6 and 7 are similar to Example 1 in charge transfer layer solution preparation, photoconductor fabrication, and testing methods. The distinction therebetween is use of non-reactive silane.

### Comparative Examples 6

The non-reactive silane was 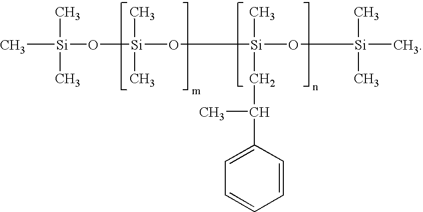
m and n are 50˜150.

### Comparative Examples 7

The non-reactive silane was 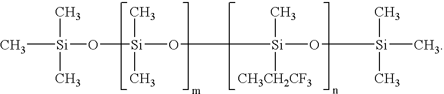
m and n are 500˜1300.
Results

Electrical Properties of Photoconductor

TABLE 1

| | Initial | | |
|---|---|---|---|
| | charging | Residual | |
| Sample | voltage (V₀) | potential (Vr) | E_{1/2} |
| Example 1 | 700 | 30 | 0.095 |
| Example 2 | 710 | 40 | 0.1 |
| Example 3 | 705 | 39 | 0.1 |
| Example 4 | 699 | 37 | 0.1 |
| Example 5 | 695 | 39 | 0.1 |
| Example 6 | 703 | 31 | 0.1 |
| Example 7 | 702 | 32 | 0.11 |
| Example 8 | 702 | 31 | 0.099 |
| Example 9 | 705 | 34 | 0.1 |
| Example 10 | 695 | 25 | 0.093 |
| Example 11 | 700 | 50 | 0.12 |
| Example 12 | 700 | 60 | 0.12 |
| Example 13 | 700 | 30 | 0.095 |
| Example 14 | 701 | 29 | 0.096 |
| Example 15 | 698 | 28 | 0.096 |
| Example 16 | 710 | 41 | 0.1 |
| Example 17 | 705 | 36 | 0.1 |
| Example 18 | 695 | 40 | 0.1 |
| Example 19 | 710 | 30 | 0.1 |
| Example 20 | 700 | 33 | 0.11 |
| Example 21 | 700 | 32 | 0.098 |
| Example 22 | 702 | 35 | 0.099 |
| Comparative | 700 | 30 | 0.095 |
| example 1 | | | |
| Comparative | 700 | 40 | 0.11 |
| example 2 | | | |
| Comparative | 702 | 65 | 0.13 |
| example 3 | | | |
| Comparative | 710 | 100 | 0.14 |
| example 4 | | | |
| Comparative | 710 | 120 | 0.14 |
| example 5 | | | |
| Comparative | 700 | 80 | 0.12 |
| example 6 | | | |
| Comparative | 704 | 85 | 0.12 |
| example 7 | | | |

Print Quality of Photoconductor

Table 2 shows print quality and abrasion resistance at 25° C. and 55% relative humidity.

TABLE 2

| | | Print | |
|---|---|---|---|
| | | quality | |
| | Print | (after | |
| | quality | printing | |
| | (printing | twenty | Film |
| | the first | thousand | abrasion |
| Sample | page) | pages) | (μm) |
| Example 1 | Good | Good | 3 |
| Example 2 | Good | Good | 3.5 |
| Example 3 | Good | Good | 3.5 |
| Example 4 | Good | Good | 3.5 |
| Example 5 | Good | Good | 3.5 |
| Example 6 | Good | Light | 4.2 |
| | | negative | |
| | | ghosting | |
| Example 7 | Good | Light | 4.2 |
| | | negative | |
| | | ghosting | |
| Example 8 | Good | Light | 4.2 |
| | | negative | |
| | | ghosting | |
| Example 9 | Good | Light | 4.2 |
| | | negative | |
| | | ghosting | |
| Example 10 | Good | Good | 3 |
| Example 11 | Good | Good | 3 |
| Example 12 | Good | Good | 3 |
| Example 13 | Good | Good | 2.5 |
| Example 14 | Good | Good | 2.5 |
| Example 15 | Good | Good | 2.5 |
| Example 16 | Good | Good | 3 |
| Example 17 | Good | Good | 3 |
| Example 18 | Good | Good | 3 |
| Example 19 | Good | Light | 3.7 |
| | | negative | |
| | | ghosting | |
| Example 20 | Good | Light | 3.7 |
| | | negative | |
| | | ghosting | |
| Example 21 | Good | Light | 3.7 |
| | | negative | |
| | | ghosting | |
| Example 22 | Good | Light | 3.7 |
| | | negative | |
| | | ghosting | |
| Comparative | Good | Good | 5 |
| example 1 | | | |
| Comparative | Good | Good | 4.5 |
| example 2 | | | |
| Comparative | Good | Good | 4 |
| example 3 | | | |
| Comparative | Negative | Serious | 3.5 |
| example 4 | ghosting; | negative | |
| | Low | ghosting; | |
| | density | Low | |
| | | density | |
| Comparative | Negative | Serious | 3.5 |
| example 5 | ghosting; | negative | |
| | Low | ghosting; | |
| | density | Low | |
| | | density | |
| Comparative | Negative | Serious | 3.5 |
| example 6 | ghosting; | negative | |
| | Low | ghosting; | |
| | density | Low | |
| | | density | |
| Comparative | Negative | Serious | 3.5 |
| example 7 | ghosting; | negative | |
| | Low | ghosting; | |
| | density | Low | |
| | | density | |

Table 3 shows print quality at 35° C. and 85% relative humidity.

TABLE 3

| | | Print quality |
|---|---|---|
| | Print quality | (after printing |
| | (printing the | twenty thousand |
| Sample | first page) | pages) |
| Example 1 | Good | Good |
| Example 2 | Good | Good |
| Example 3 | Good | Good |
| Example 4 | Good | Good |
| Example 5 | Good | Good |
| Example 6 | Good | Light negative |
| | | ghosting |
| Example 7 | Good | Light negative |
| | | ghosting |
| Example 8 | Good | Light negative |
| | | ghosting |
| Example 9 | Good | Light negative |
| | | ghosting |
| Example 10 | Good | Good |
| Example 11 | Good | Good |
| Example 12 | Good | Good |
| Example 13 | Good | Good |
| Example 14 | Good | Good |
| Example 15 | Good | Good |
| Example 16 | Good | Good |
| Example 17 | Good | Good |
| Example 18 | Good | Good |
| Example 19 | Good | Apparent |
| | | negative |
| | | ghosting |
| Example 20 | Good | Apparent |
| | | negative |
| | | ghosting |
| Example 21 | Good | Apparent |
| | | negative |
| | | ghosting |
| Example 22 | Good | Apparent |
| | | negative |
| | | ghosting |
| Comparative | Good | Good |
| example 1 | | |
| Comparative | Good | Good |
| example 2 | | |
| Comparative | Good | Good |
| example 3 | | |
| Comparative | Serious | Serious |
| example 4 | negative | negative |
| | ghosting; Low | ghosting; Low |
| | density | density and |
| | | resolution; |
| Comparative | Serious | Serious |
| example 5 | negative | negative |
| | ghosting; Low | ghosting; Low |
| | density | density and |
| | | resolution |
| Comparative | Serious | Serious |
| example 6 | negative | negative |
| | ghosting; Low | ghosting; Low |
| | density | density and |
| | | resolution |
| Comparative | Serious | Serious |
| example 7 | negative | negative |
| | ghosting; Low | ghosting; Low |
| | density | density and |
| | | resolution |

Table 4 shows print quality at 10° C. and 25% relative humidity.

TABLE 4

| | | Print quality |
|---|---|---|
| | Print quality | (after printing |
| | (printing the | twenty thousand |
| Sample | first page) | pages) |
| Example 1 | Good | Good |
| Example 2 | Good | Good |
| Example 3 | Good | Good |
| Example 4 | Good | Good |
| Example 5 | Good | Good |
| Example 6 | Good | Light negative |
| | | ghosting |
| Example 7 | Good | Light negative |
| | | ghosting |
| Example 8 | Good | Light negative |
| | | ghosting |
| Example 9 | Good | Light negative |
| | | ghosting |
| Example 10 | Good | Good |
| Example 11 | Good | Good |
| Example 12 | Good | Good |
| Example 13 | Good | Good |
| Example 14 | Good | Good |
| Example 15 | Good | Good |
| Example 16 | Good | Good |
| Example 17 | Good | Good |
| Example 18 | Good | Good |
| Example 19 | Good | Apparent |
| | | negative |
| | | ghosting |
| Example 20 | Good | Apparent |
| | | negative |
| | | ghosting |
| Example 21 | Good | Apparent |
| | | negative |
| | | ghosting |
| Example 22 | Good | Apparent |
| | | negative |
| | | ghosting |
| Comparative | Good | Light negative |
| example 1 | | ghosting |
| Comparative | Good | Good |
| example 2 | | |
| Comparative | Good | Good |
| example 3 | | |
| Comparative | Serious | Serious |
| example 4 | negative | negative |
| | ghosting; Low | ghosting; Low |
| | density | density and |
| | | resolution; |
| Comparative | Serious | Serious |
| example 5 | negative | negative |
| | ghosting; Low | ghosting; Low |
| | density | density and |
| | | resolution |
| Comparative | Serious | Serious |
| example 6 | negative | negative |
| | ghosting; Low | ghosting; Low |
| | density | density and |
| | | resolution |
| Comparative | Serious | Serious |
| example 7 | negative | negative |
| | ghosting; Low | ghosting; Low |
| | density | density and |
| | | resolution |

In Table 1, if the initial or measurement data (V₀, Vr, or E_{1/2}) is abnormal, printing defects occur. For example, low V₀ causes residual dust on media, high Vr generates ghosting, and large E_{1/2} negatively affects density and resolution. Desirable data are determined by selection of proper photoconductor materials.

See Table 2, the film thickness of the photoconductor was only decreased by 2.5 μm after printing twenty thousand pages in Examples 13˜15 due to addition of abrasion-resistant powders, with best performance. In Comparative Example 1, the film thickness of the photoconductor was decreased by 5 μm after printing twenty thousand pages due to no modification of resin and addition of any abrasion-resistant powders, with worst performance.

In Examples 6˜9, the film thickness of the photoconductor was decreased by 4.2 μm after printing twenty thousand pages due to use of shorter Si chain reactive silane, reducing abrasion resistance.

In Comparative Examples 2 and 3, the film thickness of the photoconductor is decreased by 4.5 μm and 4 μm, respectively, after printing twenty thousand pages due to different powder chemical structure from the modified resin, increased friction, worse than Example 1. In other examples, the film thickness of the photoconductor was decreased by 3.9˜3 μm after printing twenty thousand pages due to use of reactive silane or hybrid powders, greatly reducing friction and improving abrasion resistance.

See Tables 1 and 2, in Examples 6˜9 and 19˜22, wherein light negative ghosting may appear after printing twenty thousand pages due to shorter Si chain reactive silane even though electrical properties of the photoconductor and initial print quality are acceptable.

Print quality of Comparative Examples 4 and 5 utilizing reactive silane is similar to Comparative Examples 6 and 7 utilizing non-reactive one due to resin of the former is yet modified. They show high Vr (80˜120) and E_{1/2} (0.12˜0.14), causing negative ghosting and low density at initial printing and more serious after printing twenty thousand pages.

Compared to Example 1, weight ratio of reactive silane of Examples 11 and 12 is increased, resulting in higher Vr (50 or 60) and lower sensitivity (0.12), with no effect on print quality.

In Comparative Example 3, higher Vr (65) and lower sensitivity (0.13) is achieved by addition of PTFE powders, with no effect on print quality.

In other examples, their electrical properties are normal and there are no effects on print quality due to use of modified resin or addition of powders.

Compared to Tables 3 (high temperature and high humidity) and 4 (low temperature and low humidity), Examples 6˜9 show light negative ghosting, increased in Examples 19˜22 after printing twenty thousand pages due to shorter Si chain reactive silane even though initial print quality thereof is acceptable.

Print quality of Comparative Examples 4 and 5 utilizing reactive silane is similar to Comparative Examples 6 and 7 utilizing non-reactive one due to resin of the former is yet modified. Thus, print quality is affected under altered environmental conditions, causing serious negative ghosting and low density at initial printing and low resolution after printing twenty thousand pages.

In other examples, unlike Comparative Example 1 in which light ghosting appears at low temperature and low humidity after printing twenty thousand pages, optimal print quality is acquired at high or low temperature and humidity or initially or after printing twenty thousand pages due to the resin being modified by reactive silane with longer Si chain.

Table 5 shows the results of mechanical property (torque) tests of the photoconductor.

TABLE 5

| | Relative frictional |
|---|---|
| Sample | coefficient |
| Example 1 | Less than 0.5 |
| Example 2 | 0.6 |
| Example 3 | 0.625 |
| Example 4 | 0.6 |
| Example 5 | 0.7 |
| Example 6 | 0.75 |
| Example 7 | 0.7 |
| Example 8 | 0.8 |
| Example 9 | 0.7 |
| Example 10 | Less than 0.5 |
| Example 11 | Less than 0.5 |
| Example 12 | Less than 0.5 |
| Example 13 | Less than 0.5 |
| Example 14 | Less than 0.5 |
| Example 15 | Less than 0.5 |
| Example 16 | 0.625 |
| Example 17 | 0.55 |
| Example 18 | 0.65 |
| Example 19 | 0.75 |
| Example 20 | 0.7 |
| Example 21 | 0.75 |
| Example 22 | 0.75 |
| Comparative example 1 | 2 |
| Comparative example 2 | Less than 0.5 |
| Comparative example 3 | 0.65 |
| Comparative example 4 | Less than 0.5 |
| Comparative example 5 | Less than 0.5 |
| Comparative example 6 | Less than 0.5 |
| Comparative example 7 | Less than 0.5 |

The results indicate that except Comparative Example 1, having a reactive frictional coefficient of 2 due to no addition of any lubricant powders and modification of resin, other examples show a reactive frictional coefficient of 1 and less than 0.5.

Table 6 shows the results of adhesion tests between layers of photoconductor.

TABLE 6

| | Adhesion |
|---|---|
| Sample | between layers |
| Example 1 | Adhesion |
| Example 2 | Adhesion |
| Example 3 | Adhesion |
| Example 4 | Adhesion |
| Example 5 | Adhesion |
| Example 6 | Adhesion |
| Example 7 | Adhesion |
| Example 8 | Adhesion |
| Example 9 | Adhesion |
| Example 10 | Adhesion |
| Example 11 | Adhesion |
| Example 12 | Adhesion |
| Example 13 | Adhesion |
| Example 14 | Adhesion |
| Example 15 | Adhesion |
| Example 16 | Adhesion |
| Example 17 | Adhesion |
| Example 18 | Adhesion |
| Example 19 | Adhesion |
| Example 20 | Adhesion |
| Example 21 | Adhesion |
| Example 22 | Adhesion |
| Comparative example 1 | Adhesion |
| Comparative example 2 | Adhesion |
| Comparative example 3 | Adhesion |
| Comparative example 4 | Stripping |
| Comparative example 5 | Stripping |
| Comparative example 6 | Stripping |
| Comparative example 7 | Stripping |

Referring to Table 6, in Comparative Examples 4 and 5, adhesion between the charge transfer layer and charge generation layer is poor due to no modification. Similarly, in Comparative Examples 6 and 7, adhesion therebetween is also poor due to use of non-reactive silane, causing layer stripping.

Other examples have preferable adhesion therebetween.

Table 7 shows dispersion stability of hybrid powders.

TABLE 7

| | Settling time | | | | Centrifugal time | | |
|---|---|---|---|---|---|---|---|
| | One | One | Three | Six | One | Two | Three |
| Sample | week | month | months | months | hour | hours | hours |
| Example 13 | ⊚ | ⊚ | ⊚ | ⊚ | ⊚ | ⊚ | ⊚ |
| Example 14 | ⊚ | ⊚ | ⊚ | ⊚ | ⊚ | ⊚ | ⊚ |
| Example 15 | ⊚ | ⊚ | ⊚ | ⊚ | ⊚ | ⊚ | ⊚ |
| Example 16 | ⊚ | ⊚ | ⊚ | ◯ | ⊚ | ⊚ | ◯ |
| Example 17 | ⊚ | ⊚ | ⊚ | ◯ | ⊚ | ⊚ | ◯ |
| Example 18 | ⊚ | ⊚ | ◯ | ◯ | ⊚ | ⊚ | ◯ |
| Example 19 | ⊚ | ◯ | ◯ | ◯ | ⊚ | ◯ | ◯ |
| Example 20 | ⊚ | ⊚ | ◯ | Δ | ⊚ | ◯ | ◯ |
| Example 21 | ⊚ | ◯ | ◯ | ◯ | ⊚ | ◯ | ◯ |
| Example 22 | ⊚ | ◯ | ◯ | Δ | ⊚ | ◯ | ◯ |
| Comparative | ⊚ | ◯ | Δ | Δ | ⊚ | ◯ | Δ |
| example 2 | | | | | | | |
| Comparative | ◯ | Δ | X | X | Δ | Δ | X |
| example 3 | | | | | | | |

⊚ represents no subsidence, ∘ represents light subsidence, Δ represents partial subsidence, and × represents total subsidence.

During settling, except where Examples 20 and 22 display partial subsidence after six months, other examples exhibit favorable dispersion. In Comparative Example 2, powder dispersion is acceptable within one week. Nevertheless, as settling time increases, powder subsidence occurs. In Comparative Example 3, after three months, PTFE powders have totally subsided.

The results of the centrifugal experiment are similar to settling. As centrifugal time increases, dispersion deteriorates. Particularly, in Comparative Examples 2 and 3, dispersion is poor due to different powder structure from the modified resin.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A photoconductor, comprising:
a substrate;
a charge generation layer on the substrate; and
a charge transfer layer on the charge generation layer comprising a resin modified by a reactive silane.

2. The photoconductor as claimed in claim 1, wherein the substrate is aluminum.

3. The photoconductor as claimed in claim 1, wherein the resin comprises polycarbonate (PC).

4. The photoconductor as claimed in claim 1, wherein the resin comprises Z-type polycarbonate.

5. The photoconductor as claimed in claim 1, wherein the resin comprises 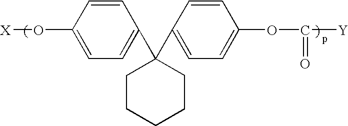
wherein X is hydrogen, Y is chlorine atom or hydroxyl group, and p is 50˜250.

6. The photoconductor as claimed in claim 1, wherein the silane comprises 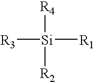
wherein R₁ comprises halogen atom, alkyl, alkenyl, cycloalkyl, aryl, alkoxy, alkenyloxy, cycloalkoxy, acyl, or acyloxy and R₂, R₃, and R₄ comprise halogen atom, alkyl halide, alkyl, or alkoxy.

7. The photoconductor as claimed in claim 1, wherein the silane comprises 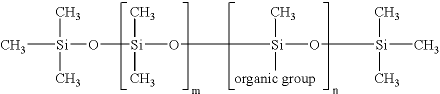
wherein m is 0˜1000, n is 0˜1000, and the organic group comprises halogen atom, amino, epoxy, carboxyl, carbinol, methacryl, mercapto, phenol, alkyl, alkenyl, cycloalkyl, aryl, alkoxy, alkenyloxy, cycloalkoxy, acyl, acyloxy, epoxy ether, or amino ether.

8. The photoconductor as claimed in claim 1, wherein the silane comprises 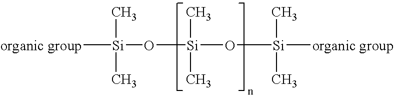
wherein n is 0˜1000 and the organic group comprises halogen atom, amino, epoxy, carboxyl, carbinol, methacryl, mercapto, phenol, alkyl, alkenyl, cycloalkyl, aryl, alkoxy, alkenyloxy, cycloalkoxy, acyl, acyloxy, epoxy ether, or amino ether.

9. The photoconductor as claimed in claim 1, wherein the silane comprises 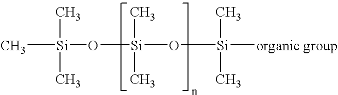
wherein n is 0˜1000 and the organic group comprises halogen atom, amino, epoxy, carboxyl, carbinol, methacryl, mercapto, phenol, alkyl, alkenyl, cycloalkyl, aryl, alkoxy, alkenyloxy, cycloalkoxy, acyl, acyloxy, epoxy ether, or amino ether.

10. The photoconductor as claimed in claim 1, wherein the silane comprises 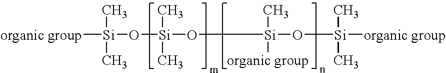
wherein m is 0˜1000, n is 0˜1000, and the organic group comprises halogen atom, amino, epoxy, carboxyl, carbinol, methacryl, mercapto, phenol, alkyl, alkenyl, cycloalkyl, aryl, alkoxy, alkenyloxy, cycloalkoxy, acyl, acyloxy, epoxy ether, or amino ether.

11. The photoconductor as claimed in claim 1, wherein the silane and the resin have a weight ratio of about 1:10000˜1:1.

12. A photoconductor, comprising:
a substrate;
a charge generation layer on the substrate; and
a charge transfer layer on the charge generation layer comprising a resin modified by a reactive silane and a hybrid powder comprising silicon dioxide and siloxane.

13. The photoconductor as claimed in claim 12, wherein the substrate is aluminum.

14. The photoconductor as claimed in claim 12, wherein the resin comprises polycarbonate (PC).

15. The photoconductor as claimed in claim 12, wherein the resin comprises Z-type polycarbonate.

16. The photoconductor as claimed in claim 12, wherein the resin comprises 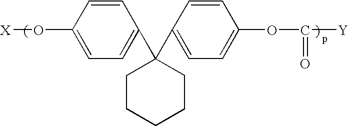
wherein X is hydrogen, Y is chlorine atom or hydroxyl group, and p is 50˜250.

17. The photoconductor as claimed in claim 12, wherein the silane comprises 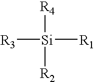
wherein R₁ comprises halogen atom, alkyl, alkenyl, cycloalkyl, aryl, alkoxy, alkenyloxy, cycloalkoxy, acyl, or acyloxy and R₂, R₃, and R₄ comprise halogen atom, alkyl halide, alkyl, or alkoxy.

18. The photoconductor as claimed in claim 12, wherein the silane comprises 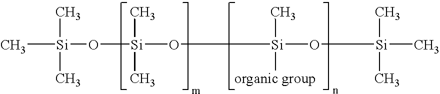
wherein m is 0˜1000, n is 0˜1000, and the organic group comprises halogen atom, amino, epoxy, carboxyl, carbinol, methacryl, mercapto, phenol, alkyl, alkenyl, cycloalkyl, aryl, alkoxy, alkenyloxy, cycloalkoxy, acyl, acyloxy, epoxy ether, or amino ether.

19. The photoconductor as claimed in claim 12, wherein the silane comprises 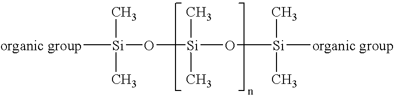
wherein n is 0˜1000 and the organic group comprises halogen atom, amino, epoxy, carboxyl, carbinol, methacryl, mercapto, phenol, alkyl, alkenyl, cycloalkyl, aryl, alkoxy, alkenyloxy, cycloalkoxy, acyl, acyloxy, epoxy ether, or amino ether.

20. The photoconductor as claimed in claim 12, wherein the silane comprises 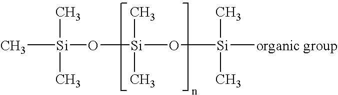
wherein n is 0˜1000 and the organic group comprises halogen atom, amino, epoxy, carboxyl, carbinol, methacryl, mercapto, phenol, alkyl, alkenyl, cycloalkyl, aryl, alkoxy, alkenyloxy, cycloalkoxy, acyl, acyloxy, epoxy ether, or amino ether.

21. The photoconductor as claimed in claim 12, wherein the silane comprises 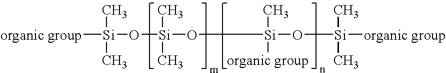
wherein m is 0˜1000, n is 0˜1000, and the organic group comprises halogen atom, amino, epoxy, carboxyl, carbinol, methacryl, mercapto, phenol, alkyl, alkenyl, cycloalkyl, aryl, alkoxy, alkenyloxy, cycloalkoxy, acyl, acyloxy, epoxy ether, or amino ether.

22. The photoconductor as claimed in claim 12, wherein the silane and the resin have a weight ratio of about 1:10000˜1:1.

23. The photoconductor as claimed in claim 12, wherein the hybrid powder comprises a siloxane rubber microsphere covered by siloxane resin.

24. The photoconductor as claimed in claim 12, wherein the hybrid powder has a diameter of about 0.05˜50 μm.

25. The photoconductor as claimed in claim 12, wherein the hybrid powder and the modified resin have a weight ratio of about 0.01˜100%.
